(19) United States
(12) Patent Application Publication
(10) Pub. No.: US 2006/0138733 A1
(43) Pub. Date: Jun. 29, 2006

(54) Suspension adjustment system

(76) Inventor: Luke Clauson, Menlo Park, CA (US)

Correspondence Address: Luke Clauson, 47 Manzanita Rd., Athertion, CA, 94027, US

(21) Appl. No.: 11/200,990

(22) Filed: Aug. 10, 2005

Related U.S. Application Data
(60) Provisional application No. 60/601,094, filed on Aug. 11, 2004.

(51) Int. Cl. B60G 17/016

(52) U.S. Cl. 280/5.508; 280/5.514; 280/6.157

(57) ABSTRACT

A retrofitable or OEM installed vehicle suspension system at least one sensor (18) capable resolving pitch and/or roll of a vehicle. The sensor (18) output is used to control wheel position with respect to the vehicle by means of at least one wheel actuator (14). Thus, the suspension and wheel position is dynamically, significantly adjusted based on the irregularities of the terrain being traversed or the pitch and roll of the vehicle.

### CROSS-REFERNCE TO RELATED APPLICATION

This application claims priority to Application No. 60/601,094, filed Aug. 11, 2004.

### BACKGROUND

This invention relates to dynamically controlled vehicle suspension systems.

### SUMMARY

Automobile OEM and aftermarket manufacturers have long sought to put terrain adaptive suspension system on their vehicles. At times this has been accomplished through passive systems with supple, long travel suspension that conform to the terrain. Other times, it is through the use of adjustable solutions such as air suspension that raises and lowers a vehicle. Examples of such systems can be found on modern Land Rover™, Porsche™, and Volkswagen™ vehicles. The range of dynamic adjustment often includes only a small portion of the travel, thus limiting its effectiveness in more extreme situations. Furthermore, OEM systems generally do not actively retract suspension members into the vehicle to force the wheel into the wheel-well, thus limiting their system's effectiveness on more uneven terrain. Most adjustable systems implemented in vehicles today raise or passively lower (let air out of air-bags) the vehicle for a given speed or user selectable setting. With current systems, vehicles are also leveled while loaded so that the passive suspension system functions optimally. Load leveling has been implemented in large hauling vehicles for many years. Alternatively, some automobile OEM's have implemented dynamically responding damping systems that continuously adjust based on constant feedback about wheel motion, vehicle dynamics and driver input but do not principally adjust suspension position. No widely available solution exists in a vehicle or through an aftermarket supplier to dynamically, significantly adjust suspension position based on the terrain being traversed. Such a system or retrofit package would have particular applicability in the extreme off-road market as well as some other market sectors. For example, a vehicle in a sharp turn would benefit from the inside (closest to the turning circle's center) suspension being dynamically lowered to counteract the rolling induced by the radially outward acceleration.

The present invention addresses the need for a retrofitable, actively adjusting suspension system, demonstrating a high degree of adaptability to various extreme terrains for increased stability and capability. The present invention also provides a cost effective solution to overcome the natural limitations of passive suspension such a vehicle pitching back when climbing a steep hill, pitching forward when decelerating quickly or swaying to the side in off-chamber or turning situations

Further advantages will become apparent from consideration of the ensuing description and drawings.

Consistent with the present invention, a retrofitable or OEM installed vehicle suspension system that dynamically, significantly adjusts suspension position based on the terrain being traversed or the pitch and roll of the vehicle.

### DESCRIPTION OF DRAWINGS

FIG. 1 shows an overview of the necessary retrofit system components.

FIG. 2 shows detail about the control module and actuation sub-system.

### DETAILED DESCRIPTION

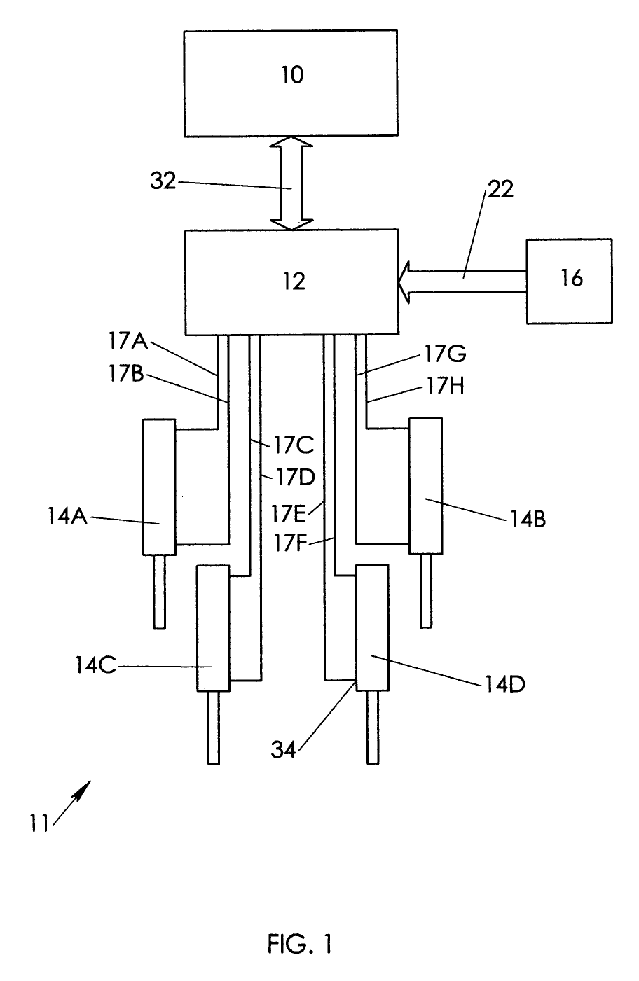

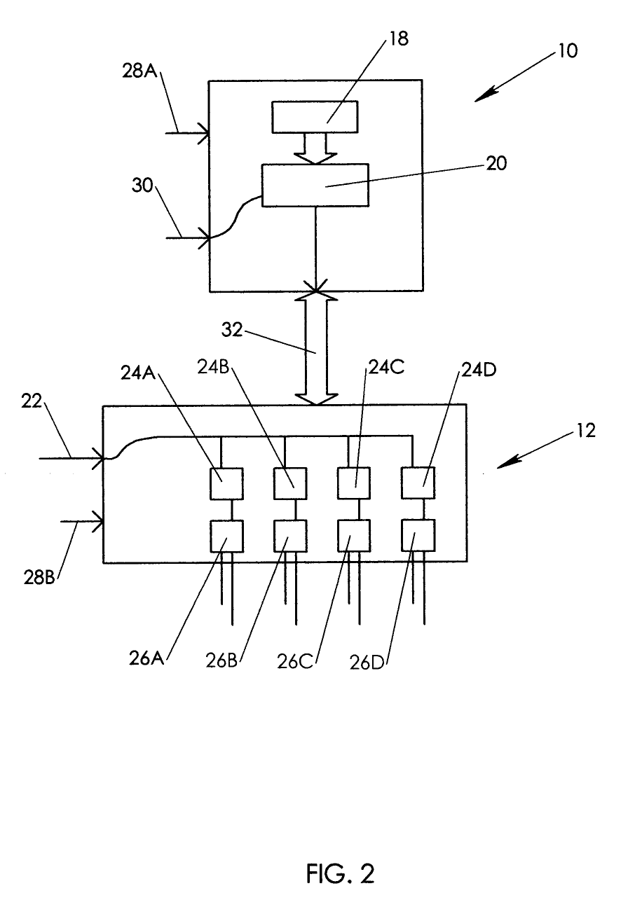

FIG. 1 shows the basic components necessary for a retrofit (or OEM) installation. FIG. 2 shows a more detailed view of the control module 10 and actuation sub-system 12. In practice, the control module 10 and actuation sub-system 12 may be housed in one enclosure. This distinction is purely a matter of convenience and for clarity's sake they will be described as separate units in this description. The system 11 includes a control module 10, having at least one sensor 18 capable resolving pitch and roll of the vehicle. The sensor 18 may be an inclinometer, solid-state pitch sensor, potentiometer with pendulum attached or any other type of sensor or sensor-assembly capable of resolving angular changes. One end of an actuator 14A-14D is attached to the suspension structure that supports each wheel (not shown) and the other end to the vehicle frame or body (not shown). Generally, at least the front suspension/wheels and/or the rear suspension/wheels would be fitted with actuators. The sensor 18 feeds its signal, which may be as an absolute angle or a relative angle from a reference point, into an electronic circuit 20. The electronic circuit 20 determines the best way to actuate each of the wheel actuator(s) 14A-14D to achieve a more stable vehicle position. The control module 10 then sends a signal over a data cable 32 to the actuation sub-system 12 which consists of a series of valves 26A-26D and proportional regulator(s) 24A-24D. The valves 26A-26D actuate the appropriate wheel actuator(s) 14A-14D, which may be a double acting air cylinder. Alternately, if only one direction of actuation is desired each actuator 14A-14D may be replaced with air bags. An air compressor 16 provides a supply of compressed air through an air pressure line 22 to the actuation sub-system 12 and finally to the wheel actuator(s) 14A-14D. Thus, the suspension is manipulating with respect to the vehicle body or frame. As the vehicle suspension is manipulated for increased stability, the control module 10 is continuously updating information on the vehicle's position by means of the pitch and roll sensor(s) 18 which in turn is signaling the actuation sub-system 12 to control the wheel actuator(s) 14A-14D as necessary. This cycle repeats continuously, creating a feedback loop based on the absolute position of the vehicle as ascertained by the control module 10 sensor 18. The proportional regulator(s) 24A-24D may be used to control the air pressure with which a wheel actuator 14A-14D is actuated. Though proportional regulator(s) 24A-24D are not absolutely necessary and may be excluded, they allow finer control of the rate and force of actuator motion. For example, if the vehicle does not require a large correction it may be advantageous to use less pressure to actuate the suspension system, allowing for a less abrupt correction. This also allows for finer control of actuator acceleration and deceleration as the vehicle nears it target positions.

A speed signal line 30 from the vehicle engine control computer communicating the vehicle's speed may be integrated into the control module 10 to allow more intelligent suspension adjustments. For example, if the vehicle is at low speeds and traversing very rough terrain the control module 10 may command large suspension position corrections. However, if the vehicle is traveling rapidly, limited suspension corrections may be appropriate due to instability they may cause in the vehicle's handling behavior. A speed signal line 30 also allows for disabling of the system 11 under certain conditions.

Though the function of the system is self-evident, two examples of its function follow. A vehicle is climbing a very steep hill which tends to pitch the vehicle backwards on its suspension, further complicating the problem of the vehicle's center of gravity having shifted backwards due to the angle of the hill. The control module 10 would send a signal to the actuation sub-system 12 to lower the front of the vehicle and raise the rear, thus either completely or partially compensating for the steep hill and pitching of the vehicle forward on its own suspension system. Likewise, if the vehicle is traversing a steep hill sideways the system 11 would command the up-hill side of the car to lower and the down-hill side to raise. Thus, stability of the vehicle is increased. In both cases the system 11 is continuously adjusting for the vehicle response to new terrain. The system 11 actively compensates for the natural negative effects of extreme terrain on vehicle traction and stability. This type of significant suspension travel position compensation is quite different from what is available from OEM's today as their systems have comparatively limited ranges of motion. Vehicles from Range Rover™ and VW™ generally set the adjustable part of the suspension at a fixed setting, or allow the user to do so, and leave it as long as the user desires. The system 11 discussed in the present invention dramatically increases the stability, traction, load distribution of the vehicle. The dynamic response created by the system 11 significantly improves the vehicle's ability to traverse very rough terrain or maintain stability during abrupt maneuvers.

Utilizing air driven wheel actuators is advantageous because they allow the normal vehicle suspension to continue to function even when actuated. If a single corner of the vehicle is being pushed up with full actuator force and that same corner's tire hits a bump the suspension can still respond due to the compressibility of the air in the air cylinder. Furthermore, by adapting the suspension position to the terrain, suspension component breakage such as axles and u-joints is far less likely due to the more equal weight distribution and traction at each wheel.

Installing the system 11 would include affixing the control module 10 to the body or frame of the vehicle in a known orientation. The actuation sub-system 12 would be affixed to the body or frame in a convenient location. A data cable 32 would run from the control module 10 to the actuation sub-system 12. Again, the control module 10 and actuation sub-system could be housed in the same enclosure if desired. The actuation sub-system 12 would require pressure line 22 from the air compressor 16 and have up to eight air lines 17A-17H. Each air line 17A-17H would be connected to one port 34 of the double acting air cylinder wheel actuator 14A-14 D at each corner of the vehicle. This allows each corner of the suspension to be driven independently in both directions. Power line(s) 28A-28B supply electricity to the control module 10 as well as the actuation sub-system 12 and a speed signal line 30 input may be used on the control module 10. Lastly, the air compressor 16 may be electric and mounted in a convenient location or belt driven off the engine and mounted under the hood. The wheel actuators 14A-14D may be installed in a configuration analogous to a shock absorber at each wheel. One end must be firmly affixed to the unibody or frame and the other end to the axle or suspension structure. Ideally, the long axis of the wheel actuators 14 would be configured in the same direction as suspension travel to optimize motion and the force applied. Thus, the system 11 could be installed with minimal fabrication in a relatively short period of time by an end user.

There are other configurations than those detailed above that rely on similar principles of actuation. The key to the system is sensing the vehicle position and then making a dynamic adjustment to improve a vehicle's stability, weight distribution and traction.

When vehicle electrical systems convert to a 36/42 volt standard it may be possible to replace the wheel actuators 14A-14D with electric actuators rather than double acting air cylinders and to remove the air compressor 16 from the system.

Though not shown, a single proportional regulator may be used in the actuation sub-system 12 rather than one for each wheel actuator 14A-14D. In this configuration, a single proportional regulator would be placed in the pressure line 22 before the valves 26A-26D. With this configuration, all the valves 26A-26D would receive the same regulated air pressure from the air compressor 16 and provide similar benefits to those described above.

The pitch and roll sensor 18 in the control module 10 could be replaced with a user operated joy stick that would be manually manipulated to control the suspension. The signal from the joy stick would be taken by the electronic circuit 20 and used to control the actuation sub-system as already disclosed. This system may be preferable to cut cost or increase simplicity in some cases. Aside from the speed signal line 30, additional data lines may be integrated into the electronic circuit, such as steering wheel angle and throttle position to improve the system 11 effectiveness.

The electronic circuit 20 may be a microprocessor, PLC or any other combination of electronic components and switches that control the operation of the valves 26A-26D and the proportional regulators 24A-24D.

The present invention has been described in connection with various preferred embodiment but it is understood that other embodiments are possible without departing from the scope of the invention.

What is claimed is:

1. A suspension adjustment system, comprising:
at least one sensor, the sensor able to resolve changes in angle,
at least one actuator attached to suspension components,
an electronic circuit to decode said sensor data and generate position commands so that said position commands are used to control the position of said actuator whereby suspension position is adjusted.

2. The system of claim 1, where said actuator is a dual acting pneumatic cylinder, able to move the suspension in both directions.

3. The system of claim 1, where said actuator is an electric actuator.

4. The system of claim 1, where said actuators are able to move the suspension system through at least 25% of its range of motion.

5. The system of claim 1, where said electronic circuit is continuously updated by said sensor to control said actuator position as appropriate.

6. The system of claim 1, where said control module accepts an input speed signal line communicating the vehicle speed for use in said position commands calculation.

7. The system of claim 1, where said sensor is an integrated circuit pitch and roll sensor.

8. The system of claim 1, where the said system is installed on an existing vehicle as a retrofit by an end user or third party.

9. The system of claim 1, whereby said suspension components closest to the turning circle's center are lowered during cornering to counteract vehicle roll induced by raidally outward acceleration.

10. The system of claim 1, whereby said suspension components position are actively adjusted to actively maintain the vehicle's center of gravity in optimal position for stability.

11. The system of claim 1, whereby said suspension components position are actively adjusted to counteract vehicle pitching during braking and acceleration.

12. A retrofitable vehicle suspension adjustment system, comprising:
at least one sensor,
at least one actuator,
a communication means coupling said sensor to said actuator so that angular changes from said sensor control said actuator position whereby, the vehicle center of gravity is adjusted based on said sensor output.
